(19) United States
(12) Patent Application Publication
(10) Pub. No.: US 2008/0228345 A1
(43) Pub. Date: Sep. 18, 2008

(54) Change Recognition And Change Protection Device And A Process For The Control Data Of A Controlled Motor Vehicle Device

(75) Inventors: Hans Heinle, Biessenhofen (DE); Hand Leistle, Wildsteig (DE)

Correspondence Address: TROUTMAN SANDERS LLP, 600 PEACHTREE STREET , NE, ATLANTA, GA, 30308, US

(73) Assignee: AGCO GmbH, Marktoberdorf (DE)

(21) Appl. No.: 12/048,927

(22) Filed: Mar. 14, 2008

(30) Foreign Application Priority Data
Mar. 15, 2007 (DE) 102007012477.7

(51) Int. Cl. G06F 7/00

(52) U.S. Cl. 701/33

(57) ABSTRACT

The control data stored in an engine control device of an agricultural utility vehicle are stored in a further control device in a redundant manner as reference data. At system initialization and in operation, a comparison is made between the control data and the reference data. If irregular deviations are determined between control data and reference data, then, as a basis for processing of the control signals, instead of the control data, the reference data or a fraction of it is used, or the control data is changed in the engine control device.

### CROSS REFERENCE TO RELATED APPLICATION

This application is based on, and claims the benefit of priority to, German application 10 2007 012 477.7, filed 15 Mar. 2007, which priority application is hereby incorporated by reference.

### BACKGROUND OF THE INVENTION

1. Field of Invention

The present invention relates to a change recognition and change protection device and change recognition and change protection process for the control data of a controlled motor vehicle device such as a vehicle engine.

2. Description of Related Art

Motor vehicles are well known, in particular agricultural utility vehicles, such as tractors, which are powered by combustion engines, in particular Diesel engines. With present Diesel engines with what is referred to as “common rail” fuel injection, the volume of air conducted to the cylinders, and in particular the volume of fuel conducted via injectors, and therefore the power output of the combustion engine, is electronically controlled.

In this situation, an engine control device processes a requirement for load or engine speed, specified for example by the driver, taking account of control data stored in the engine control device, into control signals for the drive engine. The control data provides limit values for a maximum torque of the drive engine which can be selected in specific situations. Thus, for example, in a situation in which the drive engine is running at maximum permissible revolution speed, the maximum torque which can be selected is limited to the torque imposed at that particular time, in order to prevent overrevving of the engine. In addition to the characteristics map for the revolution speed, the control data also includes other data, inter alia for the drive engine temperature or emission values. In every situation, from the large number of characteristics, the smallest currently selectable maximum torque is determined. From the torque required by the driver, or from the smallest maximum torque, if this is smaller, and on processing an injector characteristics map, a control signal is determined for the injectors and the engine output controlled.

Because the development of such engines and series production of these engines results in high costs and effort, for vehicle series with medium or small unit numbers for several performance classes, a small number of drive engines are used, or even only one. In this situation, a different output from the engines of the same construction can be achieved by the addition of a further characteristics map (hereinafter the ceiling curve characteristics map) to the control data, wherein different ceiling curves are used to provide different power outputs from engines of the same construction.

Under such circumstances the problem arises that the control data in the control device can be overwritten by unauthorized persons in order to obtain an engine with a more powerful output than intended, or the data may be altered by a defect, which can lead to deletion of the intended operating characteristics, to give unfavorable emission values, or even to damage to the drive engine.

The object of the present invention is to provide a device and a process to resolve the problem described above. In particular, a device and process are to be provided which reliably identify a change of control data in a control device and undertake countermeasures.

This object is resolved by a device according to Claim 1 and a process according to Claim 13. Additional advantageous embodiments are the subject matter of the Sub-claims.

### BRIEF SUMMARY OF THE INVENTION

According to a first aspect of the invention, a change recognition system is provided, which contains an electronic control device for a controlled vehicle device, wherein the electronic control device is adopted to contain control data, and an electronic reference device which contains reference data and is connected to the control device by means of a data transfer device. In this situation, the reference data establishes limits for value ranges within which the control data is to move. The control device or the reference device or both are adapted to compare the control data with the reference data in the electronic control device.

The control device is preferably an electronic drive engine regulating device and the controlled vehicle device is a vehicle drive engine, since it is particularly here that tampering occurs or errors can have particularly serious consequences.

Particularly suitable as a reference device is an electronic immobilizer control device, since this is already designed to communicate with the drive engine control device and, in addition, has available the necessary memory and data management capacity.

The control data are preferably situation-dependent maximum torque values, since these are an abstract, generally-valid and transferable representation of an engine output.

Particularly suitable as a data transfer device is a CAN-bus according to ISO 11898-1 to 11898-4, since, due to the transfer characteristics of this device the real-time requirements are adequately met.

It is advantageous for the reference device, control device and/or controlled vehicle device to be designed independently of one another. In a situation in which the engine and engine control are provided as an almost closed system by a supplier, this provides a motor vehicle manufacturer with the ability to out-source parts of the system to be supervised by the vehicle manufacturer.

The change recognition system referred to above can be a part of a change protection system, wherein, in addition, in the event of a difference being determined between the control data and the reference data, the control device or the reference device can change control data in the device. As a result, changed control data can be appropriately reacted to.

In this case, the control data does not necessarily have to be written back to the initial value or to a reference value. Rather, a reaction to the cause of the change can be made by the input of changed control data.

In particular, the types of control can be changed in such a way that an output of the controlled vehicle device becomes smaller than a reference output, in order that, in the event of possible damage to the control device an adequate distance interval and safety margin from overstressing can be achieved for a repeated error situation or that a deliberate attempt at tampering can be prevented or deterred by reducing the output of the controlled vehicle drive.

In addition to this, the control device and reference device in a change protection system can be designed in such a way that the control device for controlling the controlled vehicle device takes as a basis the smaller of the values from the control data and the reference data.

According to a further aspect of the invention, a change recognition process is provided, in which, after an initialization step of the control device of a controlled vehicle device, which contains control data, and after an initialization of a reference device, which is connected to the control device by means of a data transfer device and contains reference data which represent the limit values for control data, a check takes place of the control data and reference data and an optional transfer takes place of the result of the check to a device or to the driver.

If the change recognition process is a part of a change protection process, which additionally contains a subsequent change to the control data in the control device by the control device or the reference device, then it is possible to react in an appropriate manner to a control data change.

For reaction to the change and to provide safety reserves and to prevent tampering, the control data can be set to a value which does not correspond to the initial value or which signifies a reduction in the output of the controlled vehicle device.

In another change protection process, after the change recognition process has been carried out in the drive engine control, a process step is applied of taking as a basis for control the smaller value from the control data and reference data to actuate the injectors of an associated engine.

### BRIEF DESCRIPTION OF THE DRAWINGS

The invention is described below, by way of example only, with reference to the accompanying drawings in which:

FIG. 1 shows a block circuit diagram which represents constituent parts of a tractor control device,

FIG. 2 shows a data flow plan in the engine control arrangement and

FIG. 3 shows a data flow plan on changing control data in a control device.

### DETAILED DESCRIPTION OF PREFERRED EMBODIMENTS

Hereinafter an embodiment of the present invention is described, in which the motor vehicle is an agricultural tractor, the controlled vehicle device is a vehicle drive engine, the control device is an electronic engine regulating device (hereinafter Electronic Motor Control, EMC) and the data transfer device is a CAN bus.

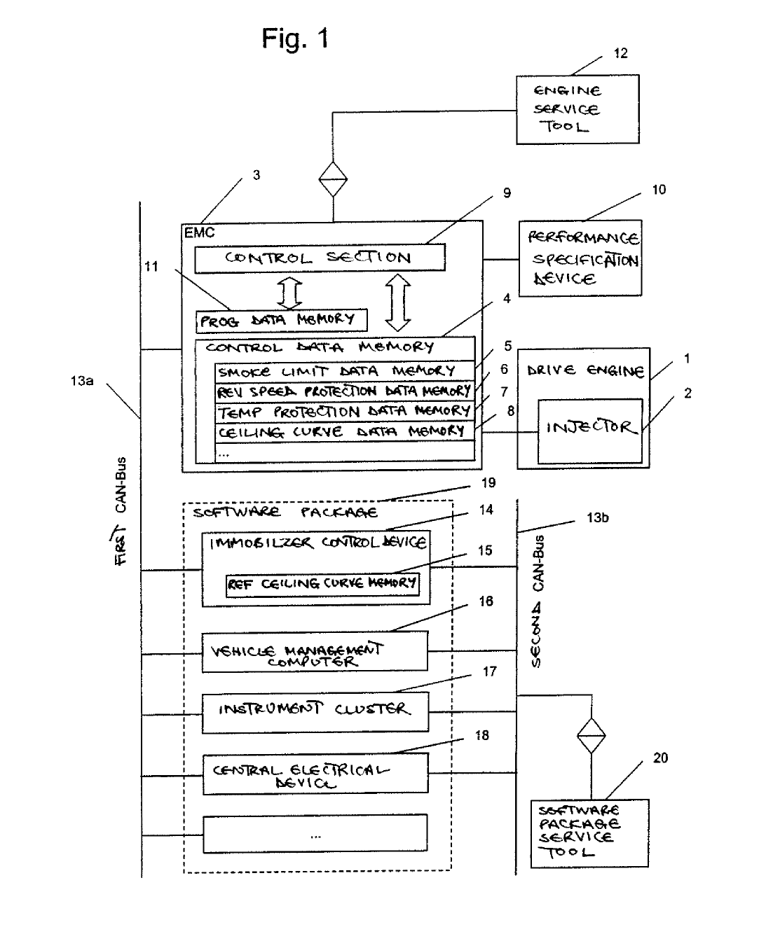

FIG. 1 shows a block circuit diagram of constituent parts of the control device of an agricultural tractor.

The agricultural tractor (not shown) has as the drive engine a turbocharged Diesel engine 1 with common rail fuel injection. This Diesel engine 1 has one or more injectors 2, which inject Diesel fuel into a combustion chamber of the Diesel engine 1. In the usual manner, by combustion of the Diesel fuel rotation of the crank shaft is produced and transferred to drive wheels. The power output and the torque of the Diesel engine 1 respectively are determined in the first instance by the volume of Diesel fuel injected by the injector 2 into the combustion chamber.

The EMC 3 has several interfaces for input and output of signals. In addition to this, the EMC 3 has a control data memory 4. This control data memory 4 is a non-volatile electronic memory such as an EPROM or a battery-buffered RAM. The control data memory 4 contains several data areas for different data, which indicate situation-dependent maximum torque values to which the Diesel engine 1 may be subjected in a specific situation. As an alternative, in this case instead of a torque value a value for fuel quantity, actuation duration, flow, power output or pressure can be used. By way of example, the following data areas may be singled out:

The control data memory 4 contains a smoke limitation data area 5. This contains data which describes a maximum torque, revolution-speed dependent, in order not to exceed specified emission values. In addition to this, the control data memory 4 is provided with a revolution speed protection data area 6, which describes a maximum torque, revolution-speed dependent, in order not to exceed a maximum revolution speed. This serves to prevent overrevving of the Diesel engine 1. The control data memory contains a temperature protection data area 7, which describes a maximum revolution speed, revolution-speed dependent, in order not to exceed a maximum temperature for the Diesel engine 1. In addition to this, the control data memory is provided with a ceiling curve data area 8, which describes a maximum torque, revolution-speed dependent. The ceiling curve data deposited in the ceiling curve data memory area corresponds to a function with revolution speeds as a definition value and torques as a target value and serves to determine a specific output of an engine and so, with engines of the same design, provide engines with different output values by means of different ceiling curves.

The EMC 3 is further provided with a control section 9, likewise programmable, which, by means of a power output specification device 10 such as an accelerator pedal, which sets the engine output wishes of the driver, and by referring to the control data stored in the control data memory 4, determines a reference torque and then an injector control signal, which is transferred to the injector 2. The EMC 3 is provided with a program data memory 11, which contains program data which determine the sequence of the data processing carried out by the control section 9.

The EMC 3 is provided with an interface for connecting an engine service tool 12. This engine service tool 12 consists of a portable data processing device and contains a program for describing control data memory 4 and program data memory 11. Which parameters can be changed by an operator of the engine service tool 12 is determined by different access levels. Thus, for example, combustion-relevant parameters can only be changed on the highest access level. Regardless of the access levels, however, a complete over-write of all parameters of the control data can be carried out. The engine service tool 12 serves, after the creation of the tractor reference control data, as control data, to transfer this into the control data memory 4 of the EMC 3 and in this way also to determine the output class of the Diesel engine 1.

EMC 3 and Diesel engine 1 are frequently parts of a largely closed system supplied by an outside manufacturer. The EMC 3 is therefore designed for use of the Diesel engine in different vehicles from different manufacturers. For cost reasons, it therefore offers only a portion of the functional performance required in the different vehicles and is only subject to a very restricted degree of ability to change by the vehicle manufacturers.

The EMC is connected to a first CAN bus 13a by means of a corresponding interface. By means of this, in what is referred to as the CSMA/CA process, data is transferred between terminals connected to the first CAN bus 13a. In one operating mode, data is transferred encoded between two terminals via the first CAN bus 13a. In this situation, what is referred to as a “seed key” encoding process is used, in which an individual initialization value for a symmetrical encoding process is used for each transfer, such that even the transfer of the same data is different and tampering with the data transfer is therefore made difficult.

Further control devices are connected to the first CAN bus 13a. For example, the following control devices may be singled out:

An immobilizer control device 14 is connected to the first CAN bus 13a. The immobilizer control device 14 stores features of valid ignition keys. If a valid ignition key is identified in the ignition, the immobilizer control device 14 sends a start clearance signal to the EMC 3. The EMC 3 in turn stores a recognition number of the immobilizer control device 14 and only issues a fuel start quantity release if it receives a start clearance signal from this specific immobilizer control device 14. In this embodiment, the immobilizer control device 14 additionally represents the reference device and contains a reference ceiling curve data memory 15. This contains reference data. The reference data in this embodiment corresponds to a function with revolution speeds as the definition value and torques as the target value, wherein the values of the function are greater than or equal to the values of the ceiling curve plus a tolerance value. The reference ceiling curve data memory 15 is protected by access protection measures and authentication measures in such a way that, in contrast to the control data memory, it cannot be changed without authorization.

A vehicle management computer 16 is connected to the first CAN bus 13a and acquires different sensor data, such as, for example, the revolution speed data of the wheels. The vehicle management computer conveys, for example, torque specified values, dependent on this revolution speed data, via the first CAN bus 13a to the EMC 3.

An instrument cluster element 17 is connected to the first CAN bus 13a, and provides a driver with sensor data such as present vehicle speed, revolution speed, fuel tank content, engine temperature and the like.

A central electrical control device 18 is also connected to the first CAN bus 13a and controls electrically powered devices such as lighting, windscreen wipers, etc.

Immobilizer control device 14, vehicle management computer 16, instrument cluster 17 and central electronic control device 18 are part of what is referred to as a software package 19 which also includes the software running in these units. The constituents of the software package 19 differ from the other devices such as the EMC 3, in that these are not closed constituent parts of a standard or non-customized Diesel engine supplied by an engine supplier but are instead prepared or adjusted by the vehicle manufacturer or by a supplier to the vehicle manufacturer in accordance with the specifications of the vehicle manufacturer. In contrast to the standard engine control system, the devices of the software package 19 are not standard and are customized entirely under the control of the vehicle manufacturer or can be provided by it or at its instigation with any desired functionality desired by the vehicle manufacturer.

The devices of the software package are, in addition, connected to a second CAN bus 13b. By means of the second CAN bus 13b, a software package service tool 20 can be connected to the system. This involves a conventional, commercial portable PC, which contains a program by means of which the different devices of the software package can be manipulated. Among other things, the program is designed in such a way that, for example, a change to the reference ceiling curve memory 15 cannot be effected by means of encoding and authorization mechanisms without the manufacturer identifying this and agreeing to it. Once the tractor has been completed, the data necessary for operation is transferred with the software package service tool to the devices of the software package 19. This data includes, among other things, as reference data the reference ceiling curve which is stored in the reference ceiling curve memory 15.

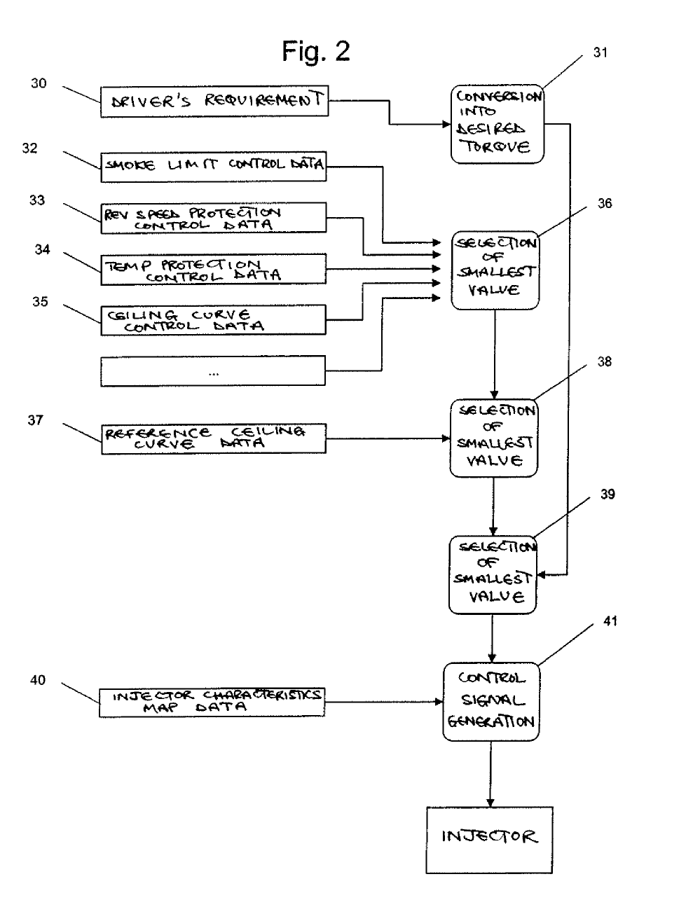

A control procedure of the EMC 3 is described on the basis of the data flow plan from FIG. 2.

By means of the output specification device (accelerator pedal) 10, a performance requirement 30 is passed to the EMC 3. This performance requirement is converted in 31 into a desired torque for the drive engine. From the smoke limitation control data 32, the revolution speed protection control data 33, the temperature protection control data 34, the ceiling curve control data 35 and other data, from the maximum torque values, which are situation-dependent, in this case revolution-speed dependent, the smallest value for the current engine torque is selected in 36. This selection of the smallest value from 36 is compared in 38 with the reference ceiling curve data 37 from the immobilizer control device 14, which is interrogated by the EMC 3 via the first CAN bus 13a from the immobilizer control device 14. In this embodiment, with a “cold start” of the EMC 3 and the immobilizer control device 14, the reference data are transferred once from the immobilizer control device 14 to the EMC 3 and are stored there in a volatile memory area until the next “cold start” of the EMC 3. This provides for low loading on the first CAN bus 13a and for less data traffic which could be tapped for the purpose of tampering. As an alternative to this, the reference data can be transferred, at every access to it, to the EMC 3 by the immobilizer control device 14. This reduces the risk of tampering with the reference data stored in the EMC 3 after initialization of the devices during operation of the vehicle.

If it is detected in 38 that the value from 36 is smaller than the value from the reference ceiling curve data 37, the value from 36 is passed on. By contrast, if the value from 36 is greater, and therefore if the values of the ceiling curve control data 35 are at least partially greater than the values of the reference ceiling curve data 37, then there is an error situation or tampering. In this case, it is advantageous not to forward the value from the reference ceiling curve data 37 but only a fraction of it, such as 70% of the value.

The torque selected in 38 is compared in 39 with the desired torque from 31. Using the smaller of these two torques from 31 and 38, and taking account of injector characteristic map data 40, a control signal is generated in 41 for the injector(s) 2.

As described heretofore, therefore, after performing a change recognition process a control signal is calculated in the EMC on the basis of a value which on the one hand is a situation-dependent value from the control data if this value is within a value range which is determined from the reference data and, on the other hand, if the value is outside the above value range, is a dependent value from the reference data. For example, it would be possible with an operational situation of 1500 rev/min for the situation-dependent value from the control data to be a maximum selectable torque of 400 Nm. The value from the reference data with this revolution speed would be, for example, a torque value of 420 Nm and sets an upwards restriction on a range for a permissible value from the control data. Because the value from the control data amounting to 400 Nm is located within a range from 0 Nm to 420 Nm, the value from the control data then becomes the basis for further control signal calculation. Otherwise the value from the reference data, in this case changed to 70% of its size, would become the basis for further control signal calculation.

In this way, it is ensured that torque during the operation of the Diesel engine 1 cannot reach an unacceptably high value. In particular, the possibility can be prevented that tampering with the ceiling curve control data in the EMC 3 brings about an increase in output in the Diesel engine 1. If in 38 only a fraction of the value from the reference ceiling curve data is passed on, then an attempt at tampering would be responded to by a reduction in the output of the Diesel engine 1.

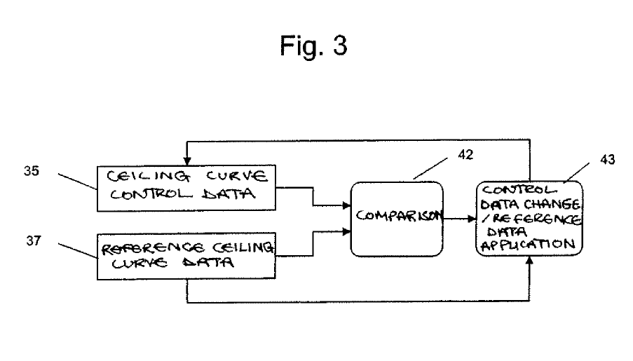

With reference to FIG. 3, a change in the ceiling curve control data 35 is described. When the tractor is started, the EMC 3 and immobilizer control device 14 are initialized. At this initialization, the EMC 3 interrogates the immobilizer control device 14, via the first CAN bus 13a, for the complete reference ceiling curve data. This data is then compared by the EMC 3 with the ceiling curve control data from the ceiling curve data area 8. If this comparison shows that the ceiling curve control data is larger in one or more points than the reference curve data, the ceiling curve data area 8 will be overwritten by the EMC 3. In this situation, the reference ceiling curve data will be read out, multiplied by a factor and written into the ceiling curve data area 8. In this embodiment, the factor is <=0.7. In further operation this has the result that, in cases in which the ceiling curve control data is determinant for the torque which is to be controlled, a reduction in output by a third or more takes place. As an alternative to overwriting the ceiling curve control data, it is possible, with regard to engine regulation, for consideration of the ceiling curve control data to be dispensed with completely and, as a substitute, to revert to the reference ceiling curve data.

In this embodiment, the control device was an EMC of a vehicle drive engine and the reference device was an immobilizer control device of the software package. As the reference device, however, other devices can be used, such as one of the other devices of the software package 19 or a dedicated data storage device, which for this purpose is connected to the first CAN bus 13a.

As the control device, other devices, in particular those with security relevance and data subject to the risk of tampering, come into consideration. Mention may be made here, for example, of devices with speed data, brake system data, data for systems such as ABS or ESP, etc.

In this embodiment, the references data represents data for performance output upper limits such as maximum torque values. The reference data can, however, also represent minimum values, such as minimum brake forces and the like. In addition to this, the reference data can also represent value ranges which are delimited both upwards as well as downwards.

We claim:

1. A change recognition system comprising:
an electronic control device for a controlled motor vehicle device, wherein the electronic control device is adapted to contain control data; and
an electronic reference device, which is adapted to contain reference data and to be connected via a data transfer device to the electronic control device,
wherein the reference data delimits a value range for permissible control data and the electronic control device or the electronic reference device or both are adapted to compare the control data with the reference data in the electronic control device.

2. A change recognition system according to claim 1, wherein the electronic reference device is an electronic immobilizer control device.

3. A change recognition system according to claim 1, wherein the electronic control device is an electronic drive engine control and the controlled motor vehicle device is a vehicle drive engine.

4. A change recognition system according to claim 1, wherein the control data represents performance output delimitation data.

5. A change recognition system according to claim 4, wherein the control data represents maximum torque values.

6. A change recognition system according to claim 1, wherein the data transfer device is selected from the group of one or more devices from ISO 11898-1 to 11898-4 (CAN bus).

7. A change recognition system according to claim 6, wherein the electronic reference device is independent of the electronic control device or of the controlled motor vehicle device or of both.

8. A change recognition system according to claim 6, wherein the electronic reference device is a customized device commissioned by a vehicle manufacturer and the electronic control device or the controlled motor vehicle device or both are both non-customized devices.

9. A change protection system having a change recognition system according to claim 1, wherein the electronic control device or the electronic reference device or both are adapted to change control data in the electronic control device if the comparison reveals that the control data does not lie in a value range delimited by the reference data.

10. A change protection system according to claim 9, wherein the electronic control device or the electronic reference device or both are adapted to change the control data in such a way that the control data does not correspond to reference control data nor to the reference data.

11. A change protection system according to claim 10, wherein the electronic control device or the electronic reference device or both are adapted to change the control data in such a way that a performance output of the controlled motor vehicle device becomes smaller than a reference output.

12. A change protection system having a change recognition system according to claim 1, wherein the electronic control device or the electronic reference device or both are adapted to take as the basis for controlling the controlled motor vehicle device a value which is the smaller of two values, the one value being derived from the control data and the other value being derived from the reference data.

13. A change protection system according to claim 12, wherein the electronic control device or the electronic reference device or both are adapted in such a way that if, for controlling the controlled motor vehicle device, a value is taken from the reference data, then the controlled vehicle device has a lower performance output than a reference output.

14. A change protection system according to claim 13, wherein the electronic control device or the electronic reference device or both are adapted in such a way that if for controlling the controlled motor vehicle device a value is taken from reference data then this value is reduced before further processing.

15. A tractor having a change recognition system according to claim 1.

16. A tractor having a change protection system according to claim 9.

17. A change recognition process comprising:
initialization of an electronic control device of a controlled motor vehicle device of a motor vehicle, containing control data,
initialization of an electronic reference device, which is connected to the electronic control device by means of a data transfer device, and contains reference control data as reference data, and
checking whether the control data lies outside a value range delimited by the reference data.

18. A change recognition process according to claim 17 further comprising transferring the result of the check to a device or to a driver of the vehicle.

19. A change recognition process according to claim 17 further comprising changing the control data in the electronic control device by means of the electronic control device or the electronic reference device.

20. A change recognition process according to claim 19, wherein changing the control data takes place in such a way that the control data does not correspond to the reference control data nor reference data.

21. A change recognition process according to claim 20, wherein changing the control data takes place in such a way that a performance output of the controlled vehicle device is less than a reference output.

22. A change protection process comprising:
carrying out a change recognition process according to claim 17; and
calculating a control signal by means of the electronic control device on the basis of a value which is either on the one hand a situation-dependent value derived from the control data if the value is within a determined value range, or on the other hand, by a situation-dependent value derived from the reference data.

23. A change protection process according to claim 22, wherein, in a case in which calculation of the control signal is to be carried out on the basis of the value from the reference data, the control signal is calculated in such a way that a performance output of the controlled motor vehicle device is smaller than a reference output.

24. A change protection process according to claim 23, wherein, in a case in which calculation of the control signal is to be carried out on the basis of the value from the reference data, this value is reduced before further processing.
